(19) United States
(12) Patent Application Publication
(10) Pub. No.: US 2004/0242239 A1
(43) Pub. Date: Dec. 2, 2004

(54) Method and apparatus for broadcasting data to mobile devices within a specific locality

(75) Inventor: Matthew Hertz, Hasharon (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: OMBEK LTD.

(21) Appl. No.: 10/445,356

(22) Filed: May 27, 2003

(51) Int. Cl. H04Q 7/20

(52) U.S. Cl. 455/456.3; 455/412.1

(57) ABSTRACT

A computer-implemented method and system for distributing mobile data to a mobile device of a specified locality, i.e. a specified home area as reflected from the phone number of the device. The method comprises the steps of accessing and retrieving from databases locality information and locality relevant message information, determining a central office code from the locality information, and transmitting a message relevant to the locality to users having mobile devices identified by the central office code.

### FIELD OF THE INVENTION

The present invention relates generally to methods for broadcasting data to wireless devices such as cellular telephones and pagers and, more particularly, to a method for the broadcasting data to mobile devices according to their locality. In this description, “locality” refers to the home area as reflected from the phone number, or more accurately to the billing area (a.k.a. rate center) of the mobile device.

### BACKGROUND OF THE INVENTION

Mobile messages (text paging, short-messaging-service (SMS), enhanced-messaging-service (EMS), multimedia-messaging-service (MMS) and other methods), referred to below as “mobile data messages” or “MDM” are messages sent from and/or to mobile devices (such as mobile phones, pagers, personal digital assistance (PDA) devices, etc.) and may contain text, pictures and sounds. Many systems were introduced in order to enable broadcast of geographically localized information corresponding with the present location of the mobile-device; these systems may utilize the device location data from different location-sensing methods or systems and can consequently provide some geographically-sensitive data to the device. Such services aimed at and correlated with the present location of a mobile device are commonly known as “Location Based Services” (LBS). Systems and methods for implementing location-based services are disclosed for example in U.S. Pat. No. 6,505,046 to Baker, and in U.S. Pat. No. 6,526,275 to Calvert. These systems and methods are based on the assumption that a user will be interested in getting local information such as weather, news, or coupons only if and when this information is relevant to his/her present location. Moreover, the premise is that the broadcasters of mobile data (e.g. marketing coupons) will be interested in reaching those users when they are located within a targeted geographic area.

The above assumption is true only in some cases, as a user who lives in a certain geographic location may be interested in his home-area (“local”) information even if and when he/she is not present in his home-area; and, using the same logic, a user may not be interested in the local news or coupons regarding the area in which he/she is at present if it is away from home. Similarly, advertisers may wish to target “native” users living within specific geographic borders, and not “foreigners” who happen to pass through these areas

Another disadvantage of existing systems is that they require location-aware wireless networks, and will not function without position-monitoring capability in the network infrastructure. Moreover, existing methods also require the mobile-data broadcasting system to be continuously connected to the network, the network being the source of this ever-changing location data, in order to acquire the position of a device at any given time.

There is therefore a need for, and it would be advantageous to have, a method and system for broadcasting data to a mobile device according to the location of its home-area, or, in other words, his “locality”.

### SUMMARY OF THE INVENTION

The present invention provides a system and method for broadcasting data to a mobile device according to its locality as reflected from the telephone number of the mobile device.

According to the present invention, there is provided a computer-implemented method for distributing mobile data to mobile devices of a specified locality comprising the steps of accessing and retrieving from a database essential mobile data message information associated with locality information; based on the locality information, determining at least one central office code associated with the locality; and transmitting a message included in said mobile data message information to users having mobile devices identified by the at least one central office code.

According to one feature in the method of the present invention, the step of accessing and retrieving essential mobile data message information includes accessing and retrieving information including a combination of message content, time to be distributed, and locality indicator.

According to another feature in the method of the present invention, the locality indicator is an indicator selected from the group consisting of city and state, zipcode, county and state, FTPS code, V-H coordinates and latitude-longitude coordinates.

According to yet another feature in the method of the present invention, the step of determining at least one central office code associated with the locality includes accessing and retrieving the at least one central office code from a V-H file matching the V-H coordinates.

According to yet another feature in the method of the present invention, the step of determining at least one central office code associated with the locality includes accessing and retrieving the at least one central office code from a V-H file matching the latitude-longitude coordinates.

According to yet another feature in the method of the present invention, the V-H coordinates and the latitude-longitude coordinates may be obtained using reference files converting the other types of locality indicators into respective V-H coordinates.

According to yet another feature in the method of the present invention, the least one central office code includes at least one close-by central office code defined by a pair of close-by V-H coordinates.

According to yet another feature in the method of the present invention, the close-by V-H coordinates are calculated using a distance calculation formula.

According to yet another feature in the method of the present invention, the step of transmitting the information to users includes communicating with a wireless network message service center or message service center gateway.

According to yet another feature in the method of the present invention, each of the mobile devices has a telephone number associated as a means of addressing the device.

According to yet another feature in the method of the present invention, the telephone number is a standard, geographic telephone number.

According to the present invention there is provided a system for distributing mobile data to a mobile device associated with a locality, comprising means for retrieving locality information correlated with the locality of the mobile user, and based on the locality information, means for distributing a locality related message to the mobile device.

According to one feature in the system of the present invention, the locality information includes locality indicator types convertible into geographical coordinates.

According to one feature in the system of the present invention, the geographical coordinates include V-H coordinates.

According to another feature in the system of the present invention, the geographical coordinates include longitude-latitude coordinates.

According to the present invention, the system of the present invention further comprises means for translating the V-H coordinates into central office code data, and wherein the means for distributing a locality related message to the mobile device include means for identifying a mobile data message relevant to the central office code.

According to yet another feature in the system the present invention, the means for distributing a locality related message to the mobile device include means for communicating with a wireless network messaging service center.

### BRIEF DESCRIPTION OF THE DRAWINGS

The invention is herein described, by way of example only, with reference to the accompanying drawings. In the drawings, like reference numbers indicate identical or functionally similar elements.

FIG. 1 shows an exemplary V-H file with conversion to latitude and longitude coordinates.

FIG. 2 shows an exemplary table in a messages database according to the present invention.

FIG. 3 shows reference tables in a localities database according to the present invention.

FIG. 4 shows a preferred embodiment of a mobile data broadcasting system according to the present invention.

FIG. 5 is a flowchart showing the process of the message distribution according to the present invention.

### DETAILED DESCRIPTION OF PREFERRED EMBODIMENTS

The present invention provides a system and method for broadcasting data to a mobile device according to its locality as reflected from the telephone number of the mobile device.

Most mobile phones and pagers in North America have an associated telephone number as a means of addressing the mobile device for voice and data communication. In addition, most telephone numbers in North America, are geographically-sensitive. In other words, they are assigned to the mobile device based on its user's geographic home area or “locality” (the exception is a toll-free telephone number, which is, by nature, a non-geographically-sensitive number). The present invention utilizes the telephone number of a mobile device as a means for determining the user's locality, and in turn, to deliver to the user mobile data relevant to his/her locality, regardless of the present location of the device. For example, according to the present invention, a New Yorker will get news on the Yankees even if he/she is in Boston, while a Bostoner will not get the same news even if he/she is in New York, because the New Yorker has a New York telephone number, and the Bostoner has a Boston telephone number.

Given the first six digits (termed the NPA-NXX) of its telephone number, the locality of a mobile device may be determined through reference to a telephone company computerized document called the “V-H” file. V-H stands for “Vertical & Horizontal”. The V-H file associates a vertical and horizontal coordinate pair to every Central Office Code (COC) in the telephone system. NPA above is the “Number Plan Area”, commonly termed the “Area Code”. NXX within an NPA (in other words, the first six digits) is the COC. The V-H Coordinate System was originated by the Bell System (now Telcordia Technologies) in the late 1950's, to determine rate mileage on toll messages. It employs the Donald Elliptic Projection (DEP), which enables the accurate calculation of the distance between points identified by their V-H coordinates without consideration of the earth's curvature. The system of the present invention uses this coordinate system as preferably delivered by Telcordia Technologies of Piscataway, N.J. The V-H Coordinate System and the DEP are described in detail for example in “Telcordia Notes on V&H Coordinates: The Mystery Unveiled” by Telcordia, Telcordia Technologies—Piscataway, N.J., July 2002.

The origin of the coordinate system is northeast of Nova Scotia at V-H coordinates (0000, 0000), and it runs to southwest of California at coordinates (9999, 9999). Thus, there are 100,000,000 distinct coordinate points covering most of Canada, the continental United States, and Mexico. The area of a square with dimensions of one coordinate unit by one coordinate unit is one tenth of a square mile. The dimensions in feet of the square unit are then the square root of one tenth of a square mile on a side, i.e. approximately 1670 feet.

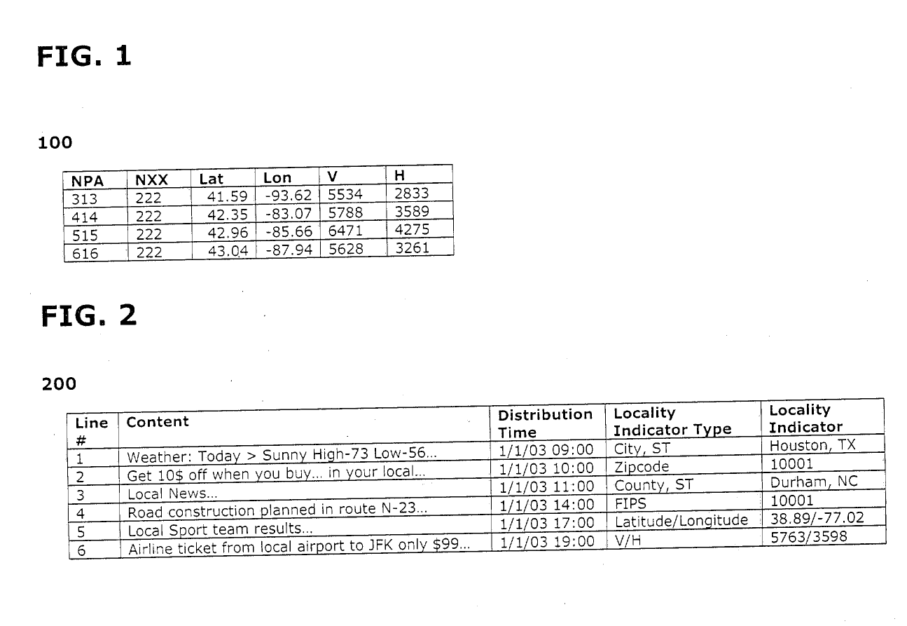

The coordinate system provides the NPA-NNX (Central Office Code) and the associated V-H coordinates of every telephone central office in the USA, Canada, and parts of Mexico. This V-H data may be converted into geographical coordinates known as latitude and longitude using standard reference files generated by V-H conversion products (one such product is “V-H Calculator” of Telcordia Technologies, Piscataway, N.J.). A converted data file provides latitude and longitude reference for each NPA-NXX (COC). An exemplary such V-H data file 100 is shown in FIG. 1. For example, if the system provides an NPA-NNX of 313-222 and an associated V-H pair of coordinates 5534-2833, the V-H calculator or similar product converts this information into a latitude coordinate 41.59 and a longitude coordinate −93.62. An example of a system for utilizing the V-H system to communicate with subscribers in a specific geographic location in given in U.S. Pat. No. 6,002,748 to Leichner. Leichner proposes to use the V-H database for ascertaining which telephone exchange should be contacted for alerting its subscribers in a disaster situation, and is unconcerned with distributing MDMs. Local telephone exchanges in a threatened geographical area connected to their subscribers and transmit a recorded warning message. This is done in response to transmission of threat data communicated from one of several remote computer terminals to a central computer. The central computer has a data storage device upon which is stored a local exchange database, and, preferably, recorded warning messages. Upon receipt of the threat data from the remote computer terminal, the central computer communicates with the local exchanges in the threatened geographical area, and instructs the local exchanges to connect to their subscribers and provide instructions or a warning message to be played to the subscribers who go off-hook.

For the distribution of mobile data messages, the system of the present invention, described in detail below, will access an internal and/or external MDM database containing local data or “content” (e.g. local news, local weather, local sport, coupons, promotions, local advertisements etc.).

An exemplary such MDM database 200 is shown in FIG. 2; each line contains the content of the message, the distribution time, and the relevant locality represented by two fields: locality indicator type and locality indicator. The locality indicator may be the name of a city plus state, the name of a county plus state, the numbers of a zipcode, a FIPS number, and V-H or latitude/longitude coordinates). The locality indicator types may represent and further clarify the locality (city & state, zip code, Federal Information Processing Standard (FIPS), etc.). For example, line 2 and line 4 both have 10001 as locality indicator but they represent two completely different localities: line 2 represents Zipcode 10001, which is New York, N.Y., and line 4 represents FIPS-code 10001, which is Kent County, Del. The same is true for line 3, where “Durham, N.C.” represents county “Durham, N.C.”. Although there is also a city “Durham, N.C.”, the “locality indicator type” is set to “County, ST”, making clear that the locality is Durham County, and not Durham City.

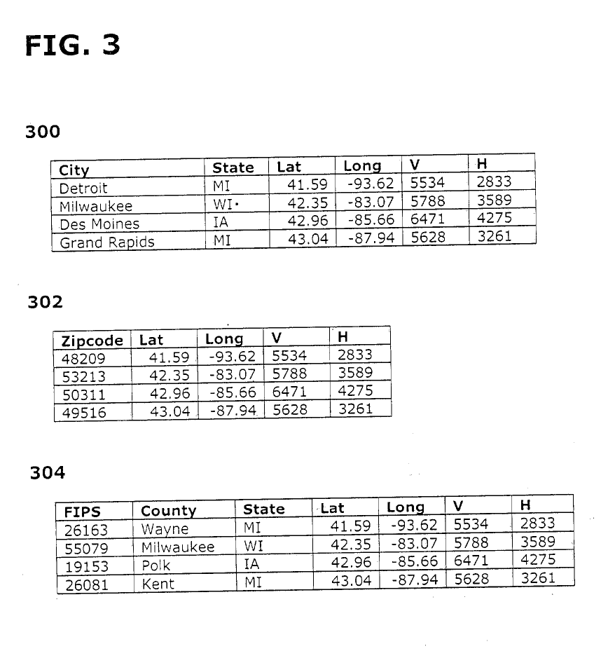

The system will then use reference files corresponding to the “locality indicator type”, e.g. reference files 300, 302, and 304 shown in FIG. 3 to convert locality indicator types that are not geographical coordinates to geographical coordinates (V-H and/or latitude and longitude). Thus, reference file 300 provides conversion of “City, State” names to geographical coordinates, reference file 302 provides conversion of “Zipcode” numbers to geographical coordinates, and reference file 304 provides conversion of “FIPS, county and state” information to geographical coordinates. The reference files may be internal or external to the system. Such reference files are available, among others, through the United States Postal Service and the US Census Bureau.

Given the arguments of V-H or latitude/longitude, the system will search V-H file 100 and retrieve the COCs in the specified locality and other, close-by localities (the latter referred to as “close-by COC”). To compute the distance between the exact home-area (locality) and a close-by locality the system will use a distance calculation formula for V-H coordinates. That is, the system will calculate the distance between two localities 1 and 2 from the two known pairs of their respective V-H coordinates, V₁/H₁ and V₂/H₂. One such formula, d=square root [(V₂−V₁)²+(H₂−H₁)²] is described in U.S. Pat. No. 4,757,267 to Riskin. If the coordinates are represented by latitude and longitude, the distance will be calculated using an earth-surface distance calculation formula such as the Haversine Formula, which was designed to calculate the distance between two points on the Earth (shown below expressed in terms of a two-argument inverse tangent function to calculate the great circle distance). If the distance in miles is equal to, or smaller than a pre-determined accuracy level (for example, an accuracy of 10 miles radius), the data item will be deemed a “close-by COC”.

Δlon=lon₂−lon₁

Δlat=lat₂−lat₁

a=(sine(Δlat/2))²+cosine(lat₁)×cosine(lat₂)×(sine(Δlon/2))²

c=2*arc tangent(√a, √(l-a))

d=R*c, (where R is the radius of the Earth)

The system will use these COCs to broadcast the MDM to any mobile user in a certain locality, by broadcasting a message to the wireless network addressed to any device in those COCs (i.e. NPA-NXX-0000, NPA-NXX-0001, NPA-NXX-0002 . . . NPA-NXX-9999). The system may broadcast the message only to some of the devices those COCs, using telephone numbers lists of targeted subscribers such as those who wish to accept broadcasted messages, and lists of blocked-subscribers such as those who asked to be excluded of broadcasted messages audience.

For the broadcasting to a wireless network, the system will communicate with the wireless network's MSC (Messaging Service Centers) or MSC Gateway, which delivers the mobile data to the devices in the network. Communication methods to such centers are well known. Specifications and communication methods can be obtained for example from their manufacturers, e.g. from LogicaCMG (Stephenson House, 75 Hampstead Road, London, NW1 2PL, UK).

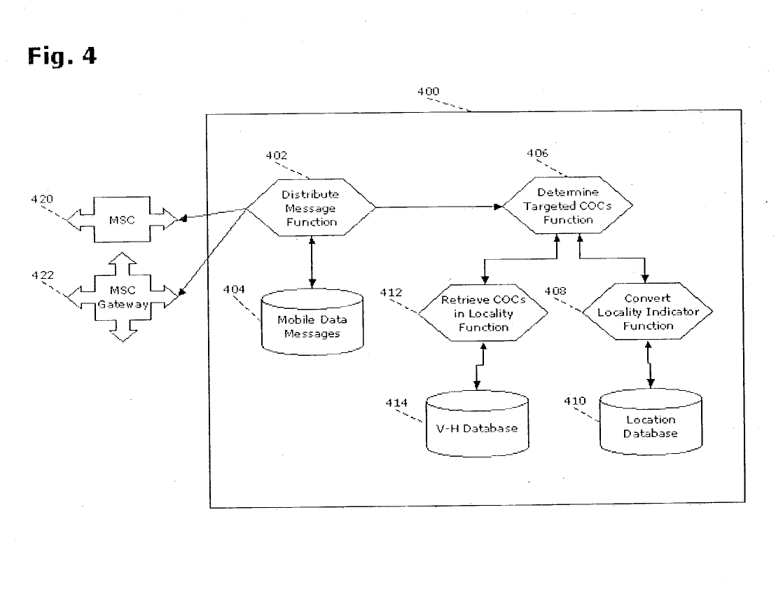

The method is preferably implemented by a computer-based system 400 shown in FIG. 4. System 400 comprises a “distribute message function” 402 in communication with a MDM database 404 that includes one or more MDM tables such as table 200 of FIG. 2. Function 402 is operative to continuously search the MDM table 200 in database 102 for MDMs that should be currently sent. Function 402 gathers the MDM details (content, the locality indicator and the locality indicator type) and calls a “determine targeted COCs” function 406, which may be internal or external to system 400 to provide it with the destination COCs. The locality indicator and the locality indicator type are then passed to function 406 as arguments.

If the coordinates (V-H or longitude-latitide) do not already represent the locality, then function 406 calls a “convert locality information function” 408. Function 408 converts the locality indicator to coordinates by searching a locality database 410 (that includes reference files such as 300, 302, and 304 in FIG. 3) for the coordinates of the given locality argument, and returns the coordinates to determine targeted COCs function 406. In turn, function 406 calls a “retrieve COCs function” 412. Given the arguments of V-H or latitude/longitide, function 412 searches a V-H database 414 and retrieves the COCs in the specified locality, as well as in other, close-by localities as defined in an “accuracy level” argument. If the distance in miles between the specified locality and a close-by locality is equal to, or smaller than the pre-determined “accuracy level”, for example the mentioned 10 mile radius accuracy level, the data item is deemed a “close-by” COC, and is returned to determine targeted COCs function 406. If the data was already in coordinates, function 406 calls immediately to retrieve COCs function 412, skipping function 408.

Function 406 returns to function 402 all the COC data in the requested locality or localities. Function 402 uses these data to broadcast the MDM to any mobile user of a certain locality, by broadcasting the message to the wireless network(s) addressed to any device in those COCs (i.e. NPA-NXX-0000, NPA-NXX-0001, NPA-NXX-0002 . . . NPA-NXX-9999). The broadcast is done via a MSC (Messaging Service Center) 420 or a MSC Gateway 422, which deliver the mobile data to the devices in the network. In one embodiment, the system is “embedded” in the MSC, in the sense that the software program can run on the MSC itself and communicate internally with the original parts of the MSC.

Function 402 may broadcast the message only to some of the devices in those COCs, using lists of telephone numbers of targeted subscribers such as those who wish to accept broadcasted messages and lists of blocked-subscribers such as those who asked to be excluded of broadcasted messages audience.

In summary, functions 406, 408 and 412 serve as means for retrieving locality information correlated with the locality of a mobile user. Function 402 serves as means for distributing a locality related message to the mobile device, and means for communicating with a network's MSC. Function 408 also serves as means for translating V-H coordinates into central office code data.

An exemplary database system that may be used for some or all of the databases 404, 410 and 414 is an Oracle database (Oracle Corp., Redwood Shores, Calif.). The retrieval of data from the database is done by standard database tools for query and update, which are well known as “Structured Query Language” (SQL) tools. SQL is described for example in “SQL: A Beginner's Guide” by Forrest Houlette, McGraw-Hill, 2000, and is well known to anyone versed in the art.

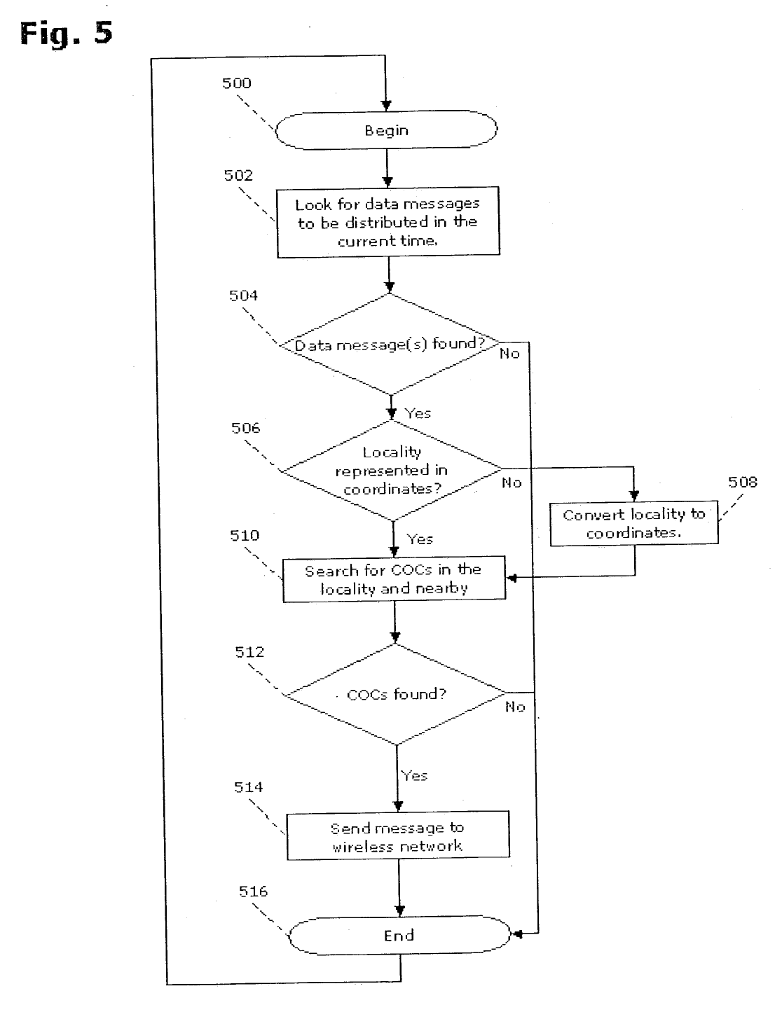

In FIG. 5, the method begins at 500. In step 502, the system, through distribution function 402, continuously searches database 404 for MDMs to be sent. That is, the system searches in every cycle of the process will search for messages to be distributed in the new current time. The system checks if such a MDM is found in step 504. When such a MDM is found, the system (through function 406) checks in a condition check step 506 if the locality indicator is represented in coordinates. If the locality indicator is not represented in coordinates, convert function 408 converts the locality indicator into coordinates in step 508. Retrieve COCs function 412 then searches V-H database 414 for COCs. If the locality indicator is already represented in coordinates in condition check step 506, retrieve COCs function searches V-H database 414 for COCs directly following step 506. The system checks if COCs were found in step 512. If COCs were found, then retrieve COCs function 412 sends the message found in step 504 to every mobile device in the above COCs in step 514.

As shown in FIG. 5, at any decision point in the process, a negative result will cause the process to end, step 516. When the process ends, it triggers itself again (500) to search for new MDMs waiting to be distributed.

The major difference between the system and method of the present invention and those disclosed in U.S. Pat. No. 6,002,748, is that the present invention does not use a local-exchange for the broadcasting. Therefore, the subscriber is not required to go off-hook. This is a major advantage of the system and method of the present invention over Leichner's. Mobile broadcast of data may be simultaneous even if the user is not available to receive the message immediately. Thus, many more messages can be simultaneously transmitted allowing for much quicker and much more efficient distribution.

The system described above can be implemented in software or hardware, or a combination of software and hardware. When implemented primarily in hardware, the system may use components such as Programmable Array Logic units (PALs), application specific integrated circuits (ASICs), or other hardware components. Implementation of a hardware state machine to perform the functions described herein will be apparent to persons skilled in the relevant art(s).

All publications and patents mentioned in this specification are herein incorporated in their entirety by reference into the specification, to the same extent as if each individual publication or patent was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. What has been described above is merely illustrative of the application of the principles of the present invention. Those skilled in the art can implement other arrangements and methods without departing from the spirit and scope of the present invention. The method of the invention can be implemented in software, which can be stored on computer disks or other computer-readable media, for execution in a host or target computer. In addition, citation or identification of any reference in this application shall not be construed as an admission that such reference is available as prior art to the present invention.

What is claimed is

1. A computer-implemented method for distributing mobile data to mobile devices of a specified locality comprising the steps of:
a) accessing and retrieving from a database essential mobile data message information associated with locality information;
b) based on said locality information, determining at least one central office code associated with the locality; and
c) transmitting a message included in said mobile data message information to users having mobile devices identified by said at least one central office code.

2. The method of claim 1, wherein said step of accessing and retrieving essential mobile data message information includes accessing and retrieving information including a combination of message content, time to be distributed, and locality indicator.

3. The method of claim 2, wherein said locality indicator is an indicator selected from the group consisting of city and state, zipcode, county and state, FIPS code, V-H coordinates and latitude-longitude coordinates.

4. The method of claim 3, wherein said step of determining at least one central office code associated with said locality includes accessing and retrieving said at least one central office code from a V-H file matching said V-H coordinates.

5. The method of claim 3, wherein said step of determining at least one central office code associated with said locality includes accessing and retrieving said at least one central office code from a V-H file matching said latitude-longitude coordinates.

6. The method of claim 3, wherein said V-H coordinates and said latitude-longitude coordinates may be obtained using reference files converting said other types of locality indicators into respective V-H coordinates.

7. The method of claim 1, wherein said at least one central office code includes at least one close-by central office code defined by a pair of close-by V-H coordinates.

8. The method of claim 7, wherein said close-by V-H coordinates are calculated using a distance calculation formula.

9. The method of claim 1, wherein said step of transmitting said information to users includes communicating with a wireless network message service center or message service center gateway.

10. The method of claim 1, wherein each of said mobile devices has a telephone number associated as a means of addressing said device.

11. The method of claim 10, wherein said telephone number is a standard, geographic telephone number.

12. A system for distributing mobile data to a mobile device associated with a locality, comprising
a. means for retrieving locality information correlated with the locality of the mobile user; and
b. based on said locality information, means for distributing a locality related message to the mobile device.

13. The system of claim 12, wherein said locality information includes locality indicator types convertible into geographical coordinates.

14. The system of claim 13, wherein said geographical coordinates include V-H coordinates.

15. The system of claim 12, wherein said geographical coordinates include longitude-latitude coordinates.

16. The system of claim 14, further comprising means for translating said V-H coordinates into central office code data, and wherein said means for distributing a locality related message to the mobile device include means for identifying a mobile data message relevant to said central office code.

17. The system of claim 12, wherein said means for distributing a locality related message to the mobile device include means for communicating with a network messaging service center.
